(19) United States
(12) Patent Application Publication
(10) Pub. No.: US 2008/0126862 A1
(43) Pub. Date: May 29, 2008

(54) System and Method for Testing Software Code for Use on a Target Processor

(75) Inventors: Michael S. Pyska, Phoenix, AZ (US); James A. Pepping, Gilbert, AZ (US); David Lawrence Wilkie, Gilbert, AZ (US)

Correspondence Address: BAKER BOTTS, LLP, 910 LOUISIANA, HOUSTON, TX, 77002-4995, US

(73) Assignee: Microchip Technology Incorporated, Chandler, AZ (US)

(21) Appl. No.: 11/467,291

(22) Filed: Aug. 25, 2006

(51) Int. Cl. G06F 11/36

(52) U.S. Cl. 714/28; 714/E11.216

(57) ABSTRACT

A system and method for testing software code for use on a target processor are disclosed. A system includes a test processor which includes a core substantially similar in physical design and functionality to the target processor for which the software code is intended to be used and an emulation ring including a logic interface to facilitate emulation of the test processor using at least one emulation methodology.

### TECHNICAL FIELD

The present disclosure relates generally to microcontrollers, and more particularly to a system and a method for testing software code for use on a target processor.

### BACKGROUND

Processors, including without limitation central processing units, microprocessors, and microcontrollers, are at the core of many electronic and electromechanical devices. For example, processors have become integral in the development, design and production of personal computers, computer peripherals and handheld computing devices. In addition, processors are often used in numerous special computer-controlled systems known as “embedded systems,” in which a computer system is completely encapsulated by the device it controls. Such embedded systems may have specific requirements and perform pre-defined tasks, unlike a general-purpose personal computer. Embedded systems have been incorporated into numerous electronic and electro-mechanical devices, including without limitation cameras, mobile phones, audio-visual equipment, automobiles, and home appliances.

Development and design of systems incorporating processors often requires testing of the both the processor and the software that is executed by the processor in order to make changes to correct problems or add features. However, for applications in which processors are to be used in embedded systems, embedded systems present special problems for developers, because they usually lack keyboards, screens, disk-drives and other helpful user interfaces and storage devices that are present on personal computers. Methods that may be used to conduct such testing for processors used in embedded systems include the use of in-circuit emulation (ICE) and in-circuit debugging (ICD).

One existing technique for debugging and testing software on a processor uses an electrically erasable and programmable read-only memory (EEPROM)-based ROM emulator that permits system programmers to store and modify ROM-based software, such as BIOS code, on a personal computer. The ROM emulator is powered by the target computer system, obviating the need for an external power supply. The software to be developed is stored in an EEPROM and may be reprogrammed either from the target computer system or though the parallel interface of a host computer system. However, this technique does not incorporate a mechanism for debugging.

Another technique involves a microcomputer comprising a flash memory, a RAM, a ROM for storing a writing program, an input/output port, and a CPU. The software code to be developed is loaded into flash memory of the microcomputer. This technique requires the presence of flash memory on the microcomputer on which the software is developed, adding undesired overhead debug circuitry.

### SUMMARY

In accordance with the teachings of the present disclosure, the disadvantages and problems associated with developing, testing and debugging a software code for use in a target processor have been substantially reduced or eliminated. In a particular embodiment, a system for testing software code for use on a target processor includes a test processor that has a core substantially similar in physical design and functionality to the target processor for which the software code is intended to be used and an emulation ring including a logic interface to facilitate emulation of the test processor using at least one emulation methodology.

In accordance with one embodiment of the present disclosure, a system for testing software code for use on a target processor includes a test processor communicatively coupled to a host and a reprogrammable memory operable to store the software code during testing and debugging. The test processor includes a core substantially similar in, physical design and functionality to the target processor for which the software code is intended to be used and an emulation ring including a logic interface to facilitate emulation of the test processor using at least one emulation methodology.

In accordance with another embodiment of the present disclosure, a test processor for use in testing and debugging software code for use in a target processor includes a core substantially similar in physical design and functionality to the target processor and an emulation ring including a logic interface to facilitate emulation of the test processor using at least one emulation methodology.

In accordance with yet another embodiment of the present disclosure, a method for testing and debugging software code for use on a target processor includes providing a test processor including a core substantially similar in physical design and functionality to the target processor and an emulation ring including a logic interface to facilitate emulation of the test processor using at least one emulation methodology. The software code is uploaded to the test processor from a host communicatively coupled to the test processor, and stored in a reprogrammable memory coupled to the test processor. The software code is executed on the test processor and data regarding the execution of the software code on the test processor is received at the host.

In accordance with a further embodiment of the present disclosure, a microcontroller includes a read only access (ROM) core substantially similar in physical design and functionality to a core of a test processor. The test processor includes an emulation ring that surrounds the core and has a logic interface to facilitate emulation of; the test processor using at least one emulation methodology. Software code tested and debugged using the test processor is stored in the ROM core.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system for testing software code for use on a target processor, as is known in the art;

FIG. 2 illustrates a system for testing software code for use on a target processor, in accordance with the present disclosure;

FIG. 3 illustrates a system for testing software code for use on a target processor using ICE methodology, in accordance with the present disclosure; and

FIG. 4 illustrates a system for testing software code for use on a target processor capable of using both ICE and IDE methodology, in accordance with the present disclosure.

### DETAILED DESCRIPTION

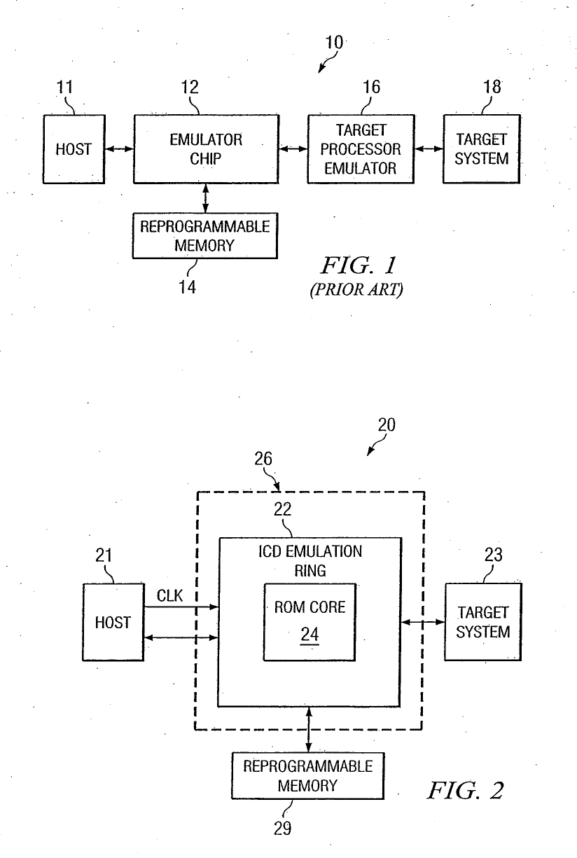

Preferred embodiments and their advantages are best understood by reference to FIGS. 1 through 4, wherein like numbers are used to indicate like and corresponding parts.

For the purposes of this disclosure, processors may include any circuit component or device that interprets instructions and processes data contained in software. Processors may include, without limitation, central processing units, microprocessors, microcontrollers, digital signal processors and application-specific integrated circuits (ASICs). Such processors may be used in any number of applications, including personal computers, computer peripherals, handheld computing devices, or in embedded systems incorporated into electronic or electromechanical devices such as cameras, mobile phones, audio-visual equipment, medical devices, automobiles and home appliances.

An in-circuit emulator is a hardware device that emulates a processor (known as the “target processor”) and may be used to test software intended to be used in the target, processor, such as a processor to be used in an embedded system. A developer may load programs into an in-circuit emulator, run the programs, step through the programs slowly, and review the results of the program's execution, and alter the program accordingly. Thus, with an in-circuit emulator, a developer may test pieces of code, isolate a fault or bug to a particular portion of the code, and then inspect the code and rewrite it to solve the problem. Often, embedded systems may have a hardware element and a software element, which are separate but tightly interdependent. ICE allows the software element to be run and tested on an emulator emulating the actual hardware on which it is to run, while allowing developers to isolate bugs in the software. One disadvantage to the use of ICE is that software is not tested on the actual processor for which the software is intended, but is instead tested on a device emulating the actual processor.

ICD is similar to ICE, but with a number of significant differences. For example, while ICE uses custom hardware to emulate a target processor, ICD uses hardware on the actual target processor to perform many of the functions of ICE. In addition, ICD employs software running on the target processor to carry out ICE-like functions. Since testing is performed without the need of separate emulation hardware, ICD is in many cases more cost-effective than ICE. Another advantage of ICD is that an ICD connector can be coupled to an application board or embedded system even after the system is in production, allowing for ease of testing, debugging and programming of the application. However, while ICD may be more cost-effective, the cost benefits come with a trade-off of some of the conveniences of ICE. For example, ICD can oftentimes only be used when all links in the target system are fully functional. As a further example, as mentioned above, ICD generally requires exclusive use of some of the hardware and software resources of the target processor. Hence, a significant advantage of existing ICD techniques is the existence of debug circuitry overhead on the target processor which may become unutilized after production of system incorporating the target processor.

FIG. 1 illustrates a system 10 for testing software code on a target processor using ICE, as is known in the art. As depicted, system 10 includes host 11, which may be any computing device, including a personal computer or workstation, capable of communicating with the other elements of system 10 and executing a test and debug program compatible with system 10 as herein described. As depicted, host 11 is communicatively coupled to emulator chip 12. Emulator chip 12 is also communicatively coupled to reprogrammable memory 14 and target processor emulator 16. Furthermore, target processor emulator 16 is communicatively coupled to target system 18.

Emulator chip 12 may be any integrated circuit device capable of facilitating communication between host 11, reprogrammable memory 14 and target processor emulator 16, such as the PIC16C04 family of emulation chips manufactured by Microchip Technologies, Inc. Reprogrammable memory 14 may include any suitable reprogrammable memory capable of storing program instructions to be executed on a target processor, and typically comprises random access memory (RAM). Target processor emulator 16 may include any type of integrated circuit capable of emulating a target processor, and typically comprises an EPROM programmed to emulate the target processor. Target system 18 may be any type of circuit which is to include the target processor emulated by target processor emulator 16. For example, target system 18 may be a computer motherboard, peripheral interconnect bus card, small computer system interface card, network interface card or other printed circuit board, and may also be a system board for an embedded system.

In operation, system 10 is used to test software code that, once tested, debugged and modified to the satisfaction of the software developer, may be used to execute on the target processor emulated by target processor emulator 16. In some embodiments, such software code may be firmware or a firmware application intended for use on the target processor. A software developer or software tester may use host 11 to upload the software to be tested by system 10. Such software may be developed or written on host 11 or any other suitable computing device. The software may be uploaded by host 11 to emulator chip 12, which then stores the program in reprogrammable memory 14 for execution by target processor emulator 16. Once the software is uploaded, the developer may, via host 11, instruct the system to execute the software on target processor emulator 16. As the software executes on target processor emulator 16, a debugging and testing program with a user interface may run on host 11 that allows the developer to control the execution of the software (for example, by pausing of the software's execution or setting breakpoints in the software code) to observe the results of the execution of the software. If the developer observes that the software is not executing as desired, the developer may modify the software to remove bugs or add features and upload the modified software to be tested by system 10. Thus, a developer may use such a debugging and testing program in connection with system 10 to test and debug software code destined to be used on a target processor.

Once a developer has completed testing and debugging of the software, the target processor emulated by target processor emulator 16 may be manufactured. In many instances, the target processor will include a read-only memory (ROM) incorporating the software developed during testing and debugging. The result is a self-contained processor which does not require reading from or writing to memory external to the processor and which includes all software code needed for the processor's desired functionality. The manufactured processor may then be incorporated into a computer system, such as a personal computer, computer peripheral, handheld computing device, or in an embedded system further incorporated into an electronic or electromechanical device such as a camera, mobile phone, audio-visual equipment, medical device, automobile or home appliance.

FIG. 2 illustrates system 20 for testing software for use on a target processor, in accordance with the present disclosure. System 20 may include host 21, which may be any computing device, including a personal computer, workstation or server, capable of communicating with the other elements of system 20 and executing a test and debug program compatible with system 20 as herein described. Host 21 may be communicatively coupled to emulator chip 22 and test processor 26. In addition, test processor 26 may be communicatively coupled to reprogrammable memory 29 and target system 28.

Reprogrammable memory 29 may include any suitable reprogrammable memory capable of storing program instructions to be executed on a target processor, including without limitation RAM and flash memory. Target system 28 may be any type of circuit which is to include the target processor emulated by test processor 26. For example, target system 28 may be a computer motherboard, peripheral component interconnect (PCI) bus card, small computer system interface (SCSI) card, network interface card or other printed circuit board, and may also be a system board to be included in an embedded system.

Although FIG. 2 may depict that host 21 of system 20 is similar to or identical to host 11 of system 10, host 21 of system 20 need not be identical to or similar to host 11 of system 10 and may be any computing device capable of the functionality contemplated herein. Additionally, although FIG. 2 may depict that target system 28 of system 20 is similar to or identical to target system 18 of system 10, target system 18 of system 20 need not be identical to or similar to target system 18 of system 10 and may be any computing device capable of the functionality contemplated herein.

Test processor 26 may be a circuit device capable of emulating a desired target processor. Test processor 26 may include an emulation ring 22 and ROM core 24. In some embodiments, emulation ring 22 and ROM core may be included within the same integrated circuit. In some embodiments, ROM core 24 may include circuitry, logic and, hardware substantially similar to a target processor to be manufactured, such that if test processor 26 did not include ME ring 22, test processor 26 would have physical and functional characteristics substantially similar to that of the target processor. Emulation ring 22 may be interfaced between ROM core 24 and the other elements of system 20 communicatively coupled to test processor 26, and may include circuitry, logic and hardware necessary to enable system 20 to emulate the target processor using any suitable debugging, testing or emulation methodology or protocol. Although FIG. 2 depicts that ROM core 24 is completely surrounded by emulation ring 22, it is understood that emulation ring 22 need not physically surround or encapsulate ROM core 24.

In operation, system 20 may be used to test software that, once tested, debugged and modified to the satisfaction of the software developer, is to execute on a target processor that is substantially similar in physical design and functionality as ROM core 24. A software developer or software tester may use host 21 to upload the software to be tested by system 20. Such software may be developed or written on host 21 or any other suitable computing device. The software may be uploaded by host 21 to the emulation ring 24 of test processor 26, which then stores the program in reprogrammable memory 29 for execution by ROM core 24 of test processor 26. Once the software is uploaded, the developer may, via host 21, instruct test processor 26 to execute the software stored in reprogrammable memory 29. As the software executes within ROM core 24, a debugging or emulation program with a user interface may run on host 21 that allows the developer to control the execution of the software by causing host 21 to communicate desired commands to emulation ring 22. Furthermore, information regarding the state of ROM core 24, such as values stored in data registers, may be communicated from ROM core 24 to host 21 via emulation ring 22. Thus, using system 20, the developer may execute software code on test processor 26, and observe the results of the execution of the software. If the developer observes that the software is not executing as desired, the developer may modify the software to remove bugs or add features and upload the modified software to be tested by system 20.

Once a developer has completed testing and debugging of the software, a target processor substantially similar in physical layout and functionality as that of ROM core 24 may be manufactured. In some embodiments, the target processor may include a physical layout substantially similar to that of ROM core 24 and may further include a ROM incorporating or otherwise storing the software code developed during testing and debugging. Thus, the software code stored in reprogrammable memory 29 during debugging and testing, once debugged and tested to the satisfaction of the software developer, may be incorporated into a ROM or other non-volatile memory disposed on the target processor. The manufactured target processor may then be incorporated into a computer system, such as a personal computer, computer peripheral, handheld computing device, or in an embedded system further incorporated into an electronic or electro-mechanical device such as a camera, mobile phone, audio-visual equipment, medical device, automobile or home appliance. In some embodiments, the manufactured target processor may be a microcontroller including a ROM core substantially similar in physical design and functionality to ROM core 24 of test processor 26, wherein software code tested and debugged using test processor 26 is incorporated or otherwise stored in the ROM core of the manufactured target processor.

Emulation ring 22 may include the necessary logic, circuitry and hardware to enable it to support any testing, debug or emulation methodology, process or protocol. In addition, emulation ring 22 may include the necessary logic, circuitry and hardware to support two or more different testing, debug or emulation methodologies, processes or protocols.

In one embodiment, emulation ring 22 may include logic to support ICD. In such an embodiment, emulation ring 22 may include logic enabling it to communicate with a host 21 running a test and debug program supporting ICD methodologies.

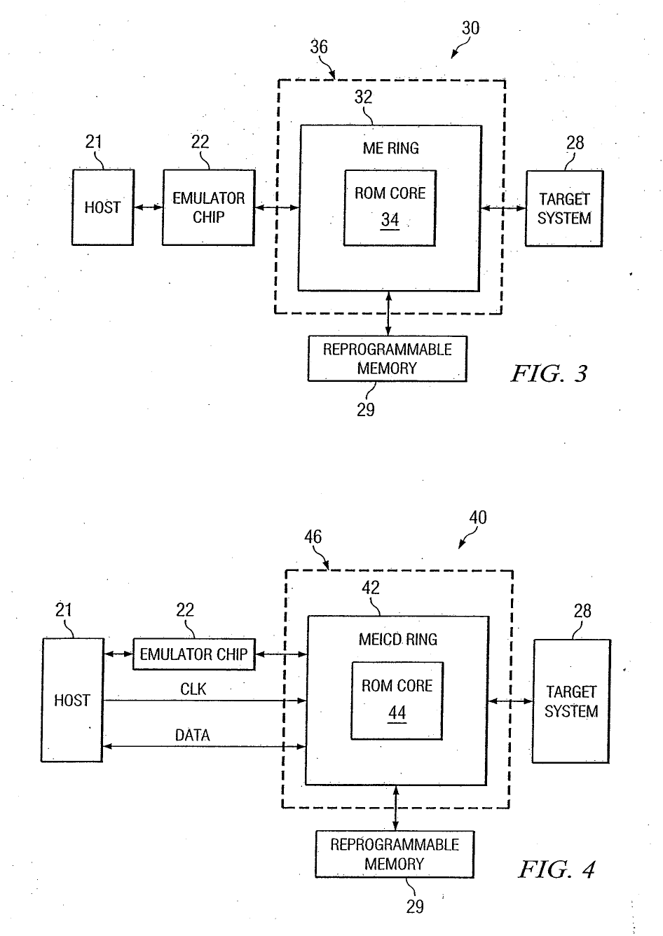

In another embodiment, emulation ring 22 may include logic to support ICE. An example of such an embodiment is depicted in FIG. 3. In FIG. 3, system 30 includes host 21, target system 28 and reprogrammable memory 29 which may be similar or identical to host 21, target system 28 and reprogrammable memory 29 of system 20 as depicted in FIG. 2. System 30 may include test processor 36 similar to test processor 26 of system 20, except that test processor 36 may include emulation ring 32 and ROM core 34. Emulation ring 32 may include logic enabling it to communicate with host 21 running a test and debug program supporting ICE methodologies. ROM core 34 may be similar or identical to ROM core 24 of system 20. Furthermore, in such an embodiment, system 30 may include an emulator chip 22, such as the PIC16C04 family of emulator chips manufactured by Microchip Technologies, Inc., interfaced between host 21 and test processor 36, to facilitate communication between host 21 and test processor 36.

In yet another embodiment, emulation ring 22 of system 20 may include logic to support both ICD and ICE. An example of such an embodiment is depicted in FIG. 4. In FIG. 4, system 40 includes host 21, target system 28 and reprogrammable memory 29 which may be similar or identical to host 21, target system 28 and reprogrammable memory 29 of system 20 as depicted in FIG. 2. System 40 may include test processor 46 similar to test processor 26 of system 20, except that test processor 46 may include emulation ring 42 and ROM core 44. Emulation ring 42 may include logic enabling it to communicate with host 21 running a test and debug program supporting both ICE and ICD methodologies. ROM core 44 may be similar or identical to ROM core 24 of system 20. Furthermore, in such an embodiment, system 40 may include an emulator chip 22, such as the PIC16C04 family of emulator chips manufactured by Microchip Technologies, Inc., interfaced between host 21 and test processor 46, to facilitate communication between host 21 and test processor 46 when using ICE.

The methods and systems disclosed herein possess numerous advantages over existing testing and debug techniques. For example, rather than emulating a target processor using a reprogrammable memory such as an EPROM, some embodiments of system 20 allow a developer to test software code using a test processor 26 with a ROM core 24 that is physically similar to, and for practical purposes, identical to the target processor. In such embodiments, because of the similarity of the ROM core 24 to the target processor which will ultimately be manufactured, data observed during emulation may be expected to have a greater accuracy and software code operation may be expected to have greater repeatability than that using conventional testing and debug techniques.

Another advantage of some of the embodiments of the methods and systems disclosed herein is that such methods and systems may utilize existing testing and debugging methodologies, processes and protocols, such as ICD and ICE, and existing testing and debugging equipment. In addition, some embodiments of this disclosure allow for the combination of two or more debugging and testing methodologies and protocols (such as a combination of ICE and ICD) into a single test and debug device, reducing overhead for developers wishing to utilize more than one testing methodology.

Additionally, since some embodiments of the methods and systems disclosed herein allow for a significant portion of the emulation and debug hardware to be included within the same integrated circuit test processor 26, testing and debugging of software may be more cost-effective.

Furthermore, in some embodiments, the debug circuitry of existing ICD techniques may be reduced, as debug circuitry incorporated into target processors using conventional ICD methods may instead be incorporated into emulation ring 22, thereby allowing target processors to be manufactured without debug overhead circuitry.

Although the present disclosure as illustrated by the above embodiments has been described in detail, numerous variations will be apparent to one skilled in the art. It is understood that various changes, substitutions and alternations can be made herein without departing from the spirit and scope of the disclosure as illustrated by the following claims.

What is claimed is:

1. A system for testing and debugging software program code for use on a target processor, comprising:
a host;
a reprogrammable memory operable to store software code operable to be executed by a target processor during testing and debugging;
a test processor communicatively coupled between the host and the reprogrammable memory, the test processor including:
a core substantially similar in physical design and functionality to the target processor; and
an emulation ring including a logic interface to facilitate emulation of the test processor using at least one emulation methodology.

2. The system of claim 1, further comprising a target system communicatively coupled to the test processor, the target system including the target processor.

3. The system of claim 2, wherein the target system comprises an embedded system.

4. The system of claim 1, wherein the reprogrammable memory comprises a random access memory or a flash memory.

5. The system of claim 1, wherein the core and the emulation ring are formed on the same integrated circuit.

6. The system of claim 1, wherein the at least one emulation methodology comprises at least one of in-circuit debugging (ICD) and in-circuit emulation (ICE).

7. The system of claim 1, wherein the target processor comprises a ROM-based microcontroller.

8. A test processor for use in testing and debugging software code for use in a target processor, comprising:
a core substantially similar in physical design and functionality to a target processor; and
an emulation ring including a logic interface to facilitate emulation of the test processor using at least one emulation methodology.

9. The test processor of claim 8, wherein the test processor is operable to read software code operable to be executed by the target the target processor from a reprogrammable memory communicatively coupled to the test processor.

10. The test processor of claim 9, wherein the reprogrammable memory comprises a random access memory or a flash memory.

11. The test processor of claim 8, wherein the core and the emulation ring are formed on the same integrated circuit.

12. The test processor of claim 8, wherein the at least one methodology comprises at least one of in-circuit debugging (ICD) and in-circuit emulation (ICE).

13. The system of claim 8, wherein the core comprises a ROM-based microcontroller.

14. A method for testing and debugging software code for use on a target processor, comprising:
providing a test processor including:
a core substantially similar in physical design and functionality to a target processor; and
an emulation ring including a logic interface to facilitate emulation of the test processor using at least one emulation methodology;
uploading software code operable to be executed by the target processor to the test processor from a host communicatively coupled to the test processor;
storing the software code in a reprogrammable memory communicatively coupled to the test processor;
executing the software code on the test processor; and
transmitting data from the test processor to the host regarding the execution of the software code on the test processor.

15. The method of claim 14, wherein the reprogrammable memory comprises a random access memory or a flash memory.

16. The system of claim 14, wherein the core and the emulation ring are formed on the same integrated circuit.

17. The method of claim 14, wherein the at least one emulation methodology comprises at least one of in-circuit debugging (ICD) or in-circuit emulation (ICE).

18. The method of claim 14, wherein the core comprises a ROM-based microcontroller.

19. A microcontroller, comprising:
a read only access (ROM) core substantially similar in physical design and functionality to a core of a test processor, the test processor including an emulation ring surrounding the core having a logic interface to facilitate emulation of the test processor using at least one emulation methodology; and
software code stored in the ROM core, the software code tested and debugged using the test processor.

20. The microcontroller of claim 19, wherein the at least one emulation methodology comprises at least one of in-circuit debugging (ICD) or in-circuit emulation (ICE).

21. The microcontroller of claim 19, wherein a host and a reprogrammable memory are communicatively coupled to the emulation ring, the reprogrammable memory operable to store the software code during testing and debugging.

22. The microcontroller of claim 21, wherein the reprogrammable memory comprises a random access memory or a flash memory.

23. The microcontroller of claim 19, wherein the software code comprises firmware.
